(19) United States
(12) Patent Application Publication
(10) Pub. No.: US 2007/0226308 A1
(43) Pub. Date: Sep. 27, 2007

(54) Method and System for Implementation of an Instant Message Service

(76) Inventor: Antti Eskelinen, Jyvaskyla (FI)

Correspondence Address: HARRINGTON & SMITH, PC, 4 RESEARCH DRIVE, SHELTON, CT, 06484-6212, US

(21) Appl. No.: 11/596,996

(22) PCT Filed: Jul. 5, 2004
(86) PCT No.: PCT/FI04/50112

§ 371 Date: Nov. 20, 2006

(51) Int. Cl. G06F 15/16

(52) U.S. Cl. 709/206

(57) ABSTRACT

The invention concerns a system for implementation of an instant message service (CHAT AB). The system includes data transmission networks, and in connection with these are arranged communication devices, which are entitled to use the data transmission network of the established operator (A, B) and which communication devices are provided with means and settings for carrying out instant messaging at least with other communication devices entitled to use the data transmission network of the established operator, and network elements, which are adapted to implement an instant message service (CHAT A) at least for communication devices entitled to use the data transmission network of the established operator (A). In connection with the network elements means (IMSS) are adapted for implementation of an operator-independent instant message service (CHAT AB).

The invention concerns a system for implementation of an instant message service, which system includes data transmission networks, of which at least some are operator-specific, and in connection with the data transmission networks the following are arranged
communication devices, which are entitled to use the data transmission network of an established operator and which communication devices are equipped with means and with settings for carrying out instant messaging at least with other communication devices entitled to use the data transmission network of the established operator, and
network elements, which are adapted to implement the instant message service at least for communication devices entitled to use the data transmission network of the established operator.

In addition, the invention also concerns a corresponding method, network element and programme products for management and implementation of the instant message service according to the invention.

In their latest device models, manufacturers of wireless communication devices have implemented so-called instant messaging applications or “chats”. This can be seen as a part of the so-called “presence services”. At least at the time of making the present application, there are not very many commercial implementations relating to presence services. Besides the mentioned instant message service, other examples of presence services are the so-called presence-enhanced contacts. Both these belong to the fastest-growing mobile station services at the present time.

Introduction of the instant message or IM service requires that the user has obtained the settings required by the service for his communication device. The settings are needed for being in connection with a special IM server and for messaging with other message users through the server. Such settings are, for example, the access point of the service i.e. the address, the user ID and the password.

However, as regards the state of the art, several practical problems relate to the implementation of IM services. Even if the user has an IM account, he must also have information of the users of the existing chat group or of the names of chat groups. In such situations in particular, which are momentary in some way or other, it may be even very difficult for the user to obtain this information. Hereby the user will not see any sense in using the services. In the present-day solutions, it may be infinitely difficult to find the chat room, which the user is looking for and which, for example, chats about a certain and even precisely defined subject matter.

Furthermore, state-of-the-art IM services are very operator-dependent, whereby the chat systems of different operators won't make conversation with one another. In practice this means that chatting, for example, between devices entitled to use the networks of different operators is not possible, but chat groups can only be formed by communication devices equipped with the subscription of one and the same operator. Especially in big mass events, users are in chat rooms of different chat operators due to this dependence on the operator. For this reason, people participating in the event do not necessarily reach other people taking part in the same event. On account of the numerous network performers, both operators and service providers, IM services cannot be said to be in any way user-friendly even for this reason.

It is a purpose of the present invention to provide a system of a new kind for implementation of instant message services. With the invention, the instant message service can be implemented in an essentially easier and simpler manner compared with the known solutions. The invention also increases the number of communicating people accessible with instant messaging. It is another purpose of the present invention also to provide a corresponding method, with which the instant message service can be implemented in a simple manner, practically between all parties capable of instant messaging in a data transmission network system. The characteristic features of the system according to the invention are presented in the appended claim 1, while the characteristic features of the method are presented in claim 7. In addition, the invention also concerns a network element and programme products for implementation of the instant message service. Their characteristic features are presented in the appended claims 12, 14 and 17.

In the system according to the invention, there are means in connection with the network elements in the data transmission networks for sending instant message settings to the communication devices in order to implement an instant message service, which is independent of the operator.

The means attending to the management and transmission of instant message settings can be arranged in several different ways in connection with the network system. For example, they may subordinated to the network operator or also to the service provider. Even otherwise the partial entities required for implementation and management of the service, such as, for example, management of settings and maintenance of the IM service proper, is not limited to any special arrangement. For example, the network server performing distribution of settings and the chat server carrying out the service proper for the communication device may be in the same equipment or they may also be separated and decentralised from each other.

The transmission of instant message settings may also take place with several different possibilities. The transmission may be carried out by order of the holder of the subscription or also in a spontaneous way originating in the network. In the ordering and sending of settings, wireless mobile station networks or also wireless local area networks known as such may be applied. Wireless local area networks make the service especially advantageous for such mass events, which are concentrated to a small area.

The instant message service may be maintained constantly or also for a limited and predetermined period of time. Hereby the invention may also be applied, for example, in connection with various momentary events. Besides the communication between users ordering the service, the service may of course be used only for providing information, for example, on matters relating to the event. The service may hereby act in the manner of an electronic “bulletin board” for the event.

In connection with the service for distribution of instant message service settings it is also possible to arrange means for maintaining and managing a user register of the service. The means may be formed by a database arranged in a memory, wherein information on the parties ordering the service is stored as well as access identifiers generated for them. According to one embodiment, a list of communication devices provided with a special status may also be maintained in the database, which devices are given established special rights relating to the service.

Significant advantages are achieved with the invention in comparison with the state of the art. Instant messaging can now be carried out between communication devices provided with subscriber identifiers of different operators. The implementation of momentary instant message services also becomes easier, and finding them and ordering them for the users is also simplified.

Other features characterising the invention emerge from the appended claims and more possible advantages are listed in the specification.

### The invention, which is not limited to the embodiments presented hereinafter, will be described in greater detail with reference to the appended figures, wherein

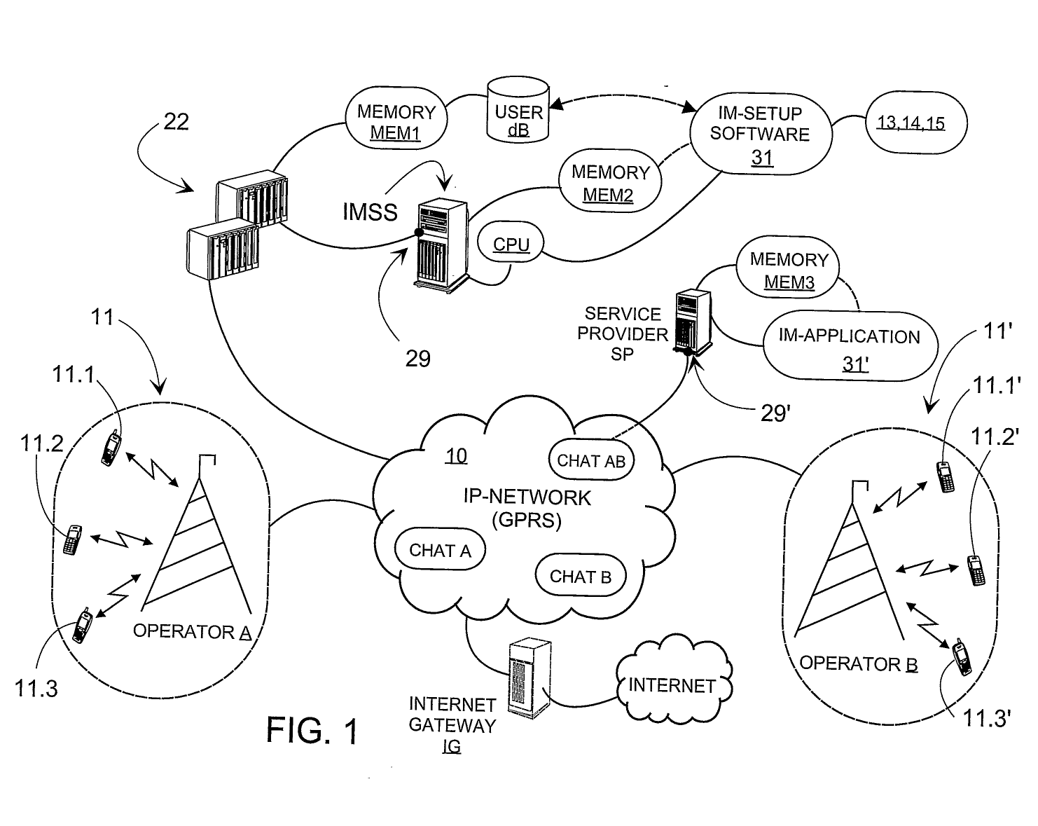

FIG. 1 is a rough schematic view as an example of a system according to the invention,

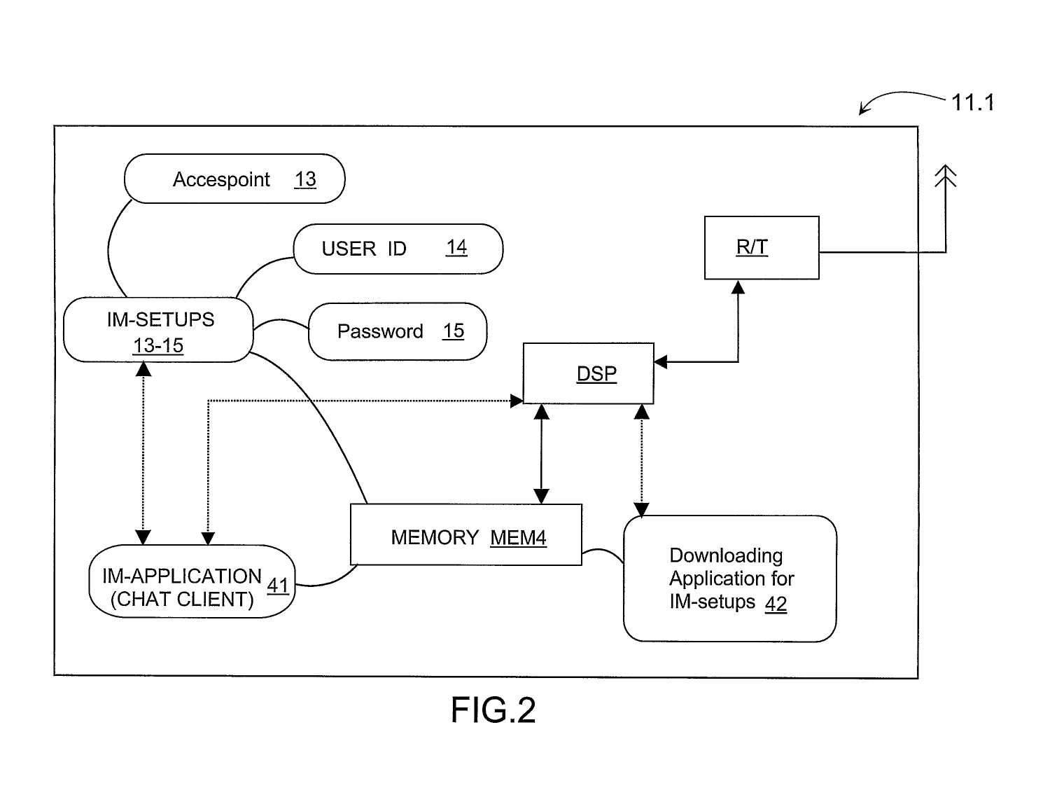

FIG. 2 is a rough schematic view as an example of a communication device,

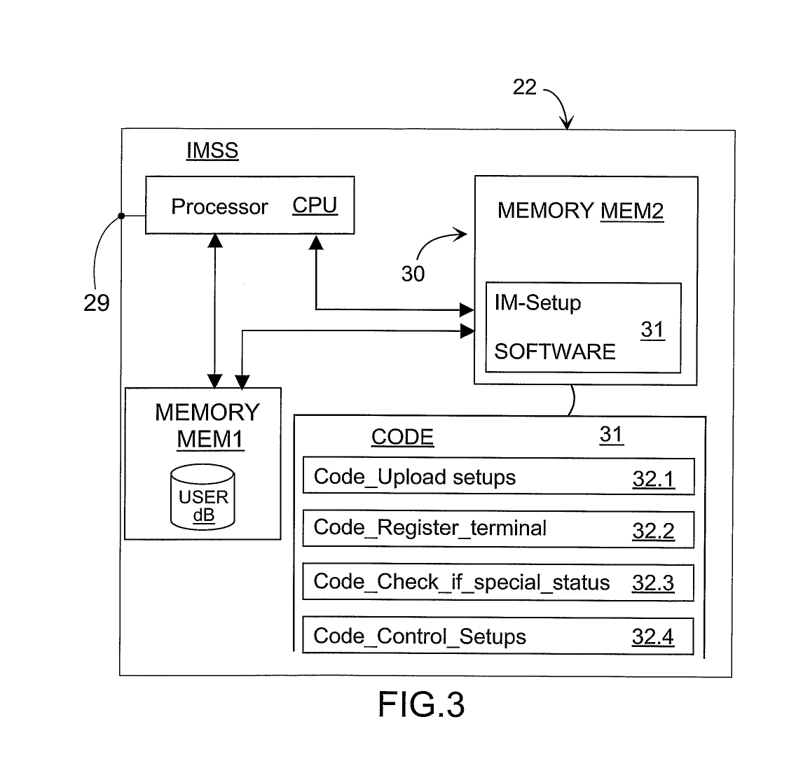

FIG. 3 is a rough schematic view as an example of functionalities of a network component according to the invention and of a first programme product arranged therein,

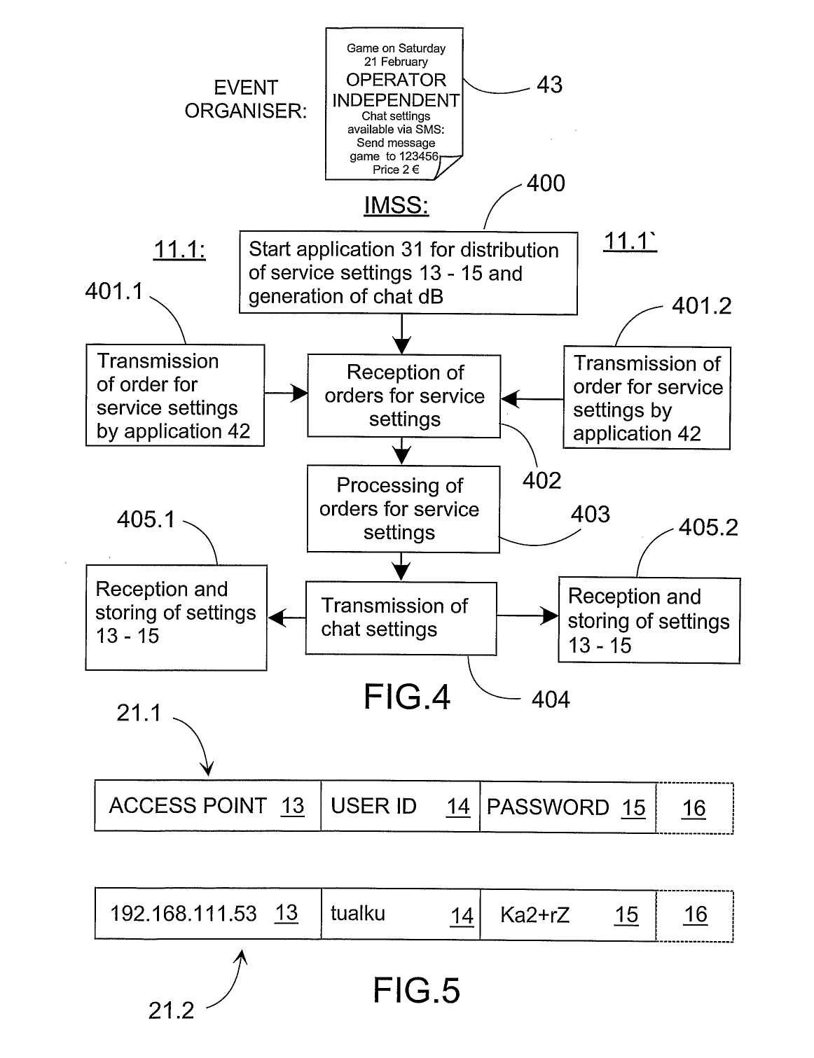

FIG. 4 is a flow chart view of an application example of the method according to the invention,

FIG. 5 shows some examples of an instant message setting data message according to the invention,

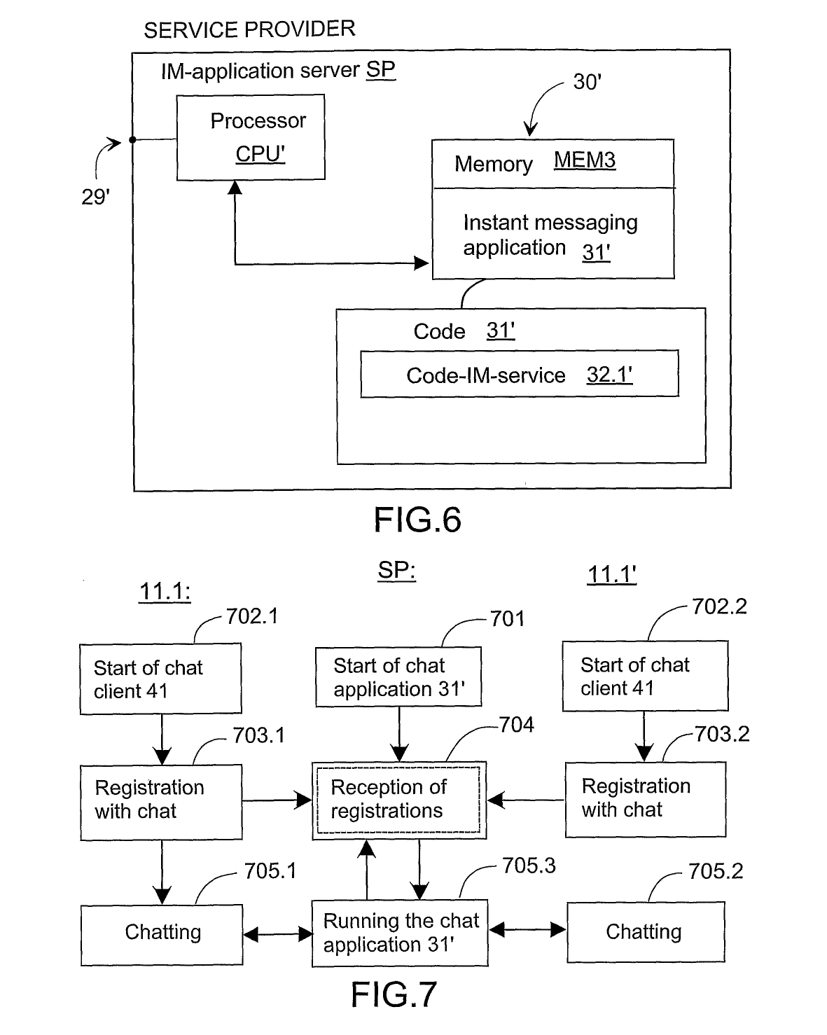

FIG. 6 is a rough schematic view as an example of an instant message application server according to the invention and of a programme product to be carried out therein, and

FIG. 7 is a flow chart view of an application example of instant messaging.

FIG. 1 is a rough schematic view as an example of a system according to the invention for implementation of an instant message service CHAT AB. The system includes a data transmission network system 10, which may include one or more data transmission networks 11, 11′. Of the data transmission networks 11, 11′, at least some may be operator-specific mobile station networks. Hereby only devices 11.1-11.3, 11.1′-11.3′ registered in the concerned network 11, 11′ are entitled to use each network 11, 11′, such as, for example, mobile stations. For example, a mobile subscription connected to the mobile station 11.1-11.3, 11.1′-11.3′ may determine the access right to the network 11, 11′.

The data transmission network 11, 11′ may be of a type already known or one still being developed. A first example of a data transmission network is a mobile station network 11, 11′, for example, (W)CDMA, TDMA, FDMA (Code/Time/Frequency Division Multiple Access) along with the different versions of these. Another example of a data transmission network is a wireless local area network, for example, a Bluetooth or WLAN network (Wireless Local Area Network). The network system 10 may also consist of several inter-connected network systems 11, 11′.

According to one embodiment, the data transmission network system 10 may be a packet data network, such as, for example, an IP (Internet Protocol) -based network, whereby the instant messaging carried out in the network 10 advantageously takes place in packet form. An example, although not a limiting one, of such a network is the GPRS (General Packet Radio Network) network.

The data transmission network 11, 11′ or, more generally, the network system 10 formed by them, may include network elements 22 known as such for allowing and carrying out communication between communication devices 11.1-11.3, 11.1′-11.3′ communicating therein. These components 22 will not be specified more precisely in this context, because from the viewpoint of the invention they may even as such be of a kind known to the professional in the art.

Thus, in network system 10 numerous communication devices 11.1-11.3, 11.1′-11.3′ may be in communication with each other. Each one of them is entitled in its up-link communication to use the data transmission network 11, 11′ of at least one established operator or even of more established operators A, B. In this context, the operator can be understood as, for example, a network operator A, who owns and controls his physical network 11.

FIG. 2 is a rough schematic view of a communication device 11.1 shown as an example. The communication device 11.1 is equipped with transmitter and receiver means R/T and memory means MEM4 known as such, wherein there are or can be arranged settings 13-15 for access to the instant message service CHAT AB and for messaging through it. Furthermore, device 11.1 may include a client application 41 for carrying out instant messaging and a possible application 42 for ordering and processing settings 13-15 by the device 11.1.

The device 11.1, which is provided with a subscriber connection of operator A and is thus registered in network 11 and entitled to use it, may be used to perform instant messaging in accordance with the state of the art at least with other communication devices 11.2-11.3, which are entitled to use the same established operator's A data transmission network 11, according to the settings. Hereby instant messaging takes place from devices 11.1′-11.3′ provided with subscriber connections of other operators B in a closed manner in a service CHAT A of their own. Correspondingly, a closed operator-specific instant message service CHAT B of a known kind can also be arranged for those devices 11.1′-11.3′ registered in operator B's network 11′, to which there is no access for communication by the devices 11.1-11.3 of other operators A.

Generally speaking, instant message services CHAT A, CHAT B, CHAT AB arranged in network 10 can be implemented, such as, for example, managed and/or run by some applicable one or more network elements 22.

FIGS. 1 and 3 show a rough schematic example of a network element 22 according to the invention, which can be applied in connection with the system 10 for distributing instant message settings 13-15 in the manner according to the invention. As was already mentioned earlier, all the functionalities which are needed for implementation of the invention can be arranged in either one or in more network elements 22, such as, for example, in a server. In connection with network element 22 there are means IMSS for transmission of instant message settings 13-15 to communication devices 11.1-11.3, 11.1′-11.3′ in order to implement an instant message service CHAT AB, which is independent of operators. Settings 13-15 can be transmitted, for example, based on a setting order made by the communication devices 11.1-11.3, 11.1′-11.3′ or also by the party maintaining the service without any setting order received from the devices or based on an order made by some third party, as will be explained in greater detail hereinafter.

In connection with the network element 22 according to the invention there may be a server functionality IMSS including processor means CPU for carrying out programme codes 32.1-32.4. In this context there is no need to explain the technical implementation of network element 22 in greater detail, because the professional in the art has numerous practical alternatives for arranging it. For example, it may be in connection with a Mobile Station Center (MSC), an SMS server or some other such network component.

On the other hand, the server functionality IMSS, which is to be regarded as a network element, may even be entirely separate from the functions maintaining the network system 10 and relaying communication therein. An example of such is, for example, a server arranged in connection with the service provider SP and equipped with wireless means of communication, which server distributes service settings 13-15 to those mobile stations which have ordered them. Hereby the server may also be equipped with a subscriber identifier, whereby it is equal with the other communication means connected to the network system 10 (not shown).

The interface of network element IMSS is indicated by reference number 29. Interface 29 may be wireless, if server IMSS is not in a fixed connection, for example, with the mobile station center 22.

In connection with the server IMSS in connection with network element 22 there may be second means MEM1 for a user register dB of the instant message service CHAT AB, such as, for example, for its maintenance and control. The second means may include a memory medium MEM1, wherein an updateable user database dB can be maintained. The devices 11.1-11.3, 11.1′-11.3′, which have ordered instant message settings 13-15, can be registered in a database dB and furthermore the mobile subscriptions connected to them. Database dB and also orders for and distribution of instant message settings 13-15 in general can be managed by a programme code 31 executed by the processor CPU of server IMSS. Programme code 31 is stored on a suitable storage medium MEM2, thus forming a programme product 30 according to the invention.

It should be noted that user database dB may be immediately in connection with server IMSS, as is shown in FIG. 3, or it may also be separate, as is shown in FIG. 1.

FIG. 3 shows a rough schematic view of an application example of functionalities arranged for the setting server IMSS according to the invention. FIG. 3 also shows a first programme product 30 arranged in connection with server IMSS for management of instant message settings 13-15 independent of operators and for distributing them to the communication devices 11.1-11.3, 11.1′-11.3′ of network system 10.

Thus, programme product 30 includes a storage medium MEM2 and a programme code 31 executable with processor means CPU and written in the storage medium MEM2 for distribution and management of instant message service settings 13-15 in the data transmission network system 10.

Programme code 31 may include several code means 32.1-32.4, which can be executed by processor means CPU and the function of which will be described in greater detail in a method description to be given later. The codes may form a set of processor commands, which can be executed one after the other and which are used to bring about the functionalities needed in the invention. Of these, the first code means 32.1 may be configured to transmit instant message settings 13-15 to the communication devices 11.1-11.3, 11.1′-11.3′ for the instant message service CHAT AB independent of operators.

Programme code 31 may also include second code means 32.2. This may be configured to register the communication device 11.1-11.3, 11.1′-11.3′, which has ordered instant message settings, along with its subscriber identity. Registration is of administrative significance, for example, in a case where it is desirable to charge the subscriber even for ordering settings 13-15. On the other hand, also the identification of the type of equipment may be significant, if as regards the client applications 41 to be executed therein or as regards setting requirements there are differences between different manufacturers/user interfaces.

Furthermore, programme code 31 may also include a third code means 32.3. This may be configured to interpret whether the communication device 11.1-11.3, 11.1′-11.3′ ordering instant message settings 13-15 fulfils any special established criteria. An example of such special criteria may be a so-called client device, for which special rights may be established, which will be described later in greater detail.

Yet a fourth code means 32.4, which may also belong to the programme code 31, is a functionality to do with the management of settings 13-15. This may include algorithms for generating settings, such as, for example, user identifiers 14 and passwords 15 for ordering parties and for holders of subscription provided with a special status.

FIG. 4 is a flow chart of an embodiment of the method according to the invention. The holders of communication devices 11.1, 11.1′ (not shown) find, for example, in today's newspaper an ad 43 for a football match. The supply of auxiliary services of the match may also include a chat group CHAT AB, wherein in connection with the match, such as, for example, during it and possibly also before and after the match during a predetermined period of time it is possible to carry out an instant message chat with communication devices 11.1, 11.1′ according to the invention independently of operators. The ad 43 also contains contact information, from which interested persons can order for their devices the instant message settings 13-15, which are needed for access to the chat group CHAT AB. Other channels than the presented newspaper ad may be used to advertise the chat service CHAT AB.

It should be noted that although the invention is described here in connection with a sports event, its application is in no way limited to such mass events, whose nature is, for example, momentary or otherwise predetermined in some manner. The invention can also be applied in fair or festival events or generally also in permanent IM services irrespective of the theme or without limiting it in any way.

In step 400, the operator, such as, for example, the network operator A, B or alternatively the service provider SP uses the setting server IMSS of the IM service to generate, for example, a database dB. Database dB may be used to register service setting orders received from communication devices 11.1-11.3, 11.1′-11.3′. Server IMSS is also used to start the execution of software 31 for management of IM settings 13-15, whose code means 32.1-32.4 have already been described above.

In step 401.1, 401.2, users use their communication devices 11.1, 11.1′ to order instant message settings 13-15 for their devices. The order may be made by using application 41 over the air (OTA) by sending, for example, a SMS message of a certain form through data transmission network system 10 to server IMSS. The SMS message is sent, for example, to the identifier 123456 mentioned in the newspaper ad 43. Other ways of ordering are of course also possible. An example of these could be ordering of service settings 13-15 through the Internet network or through a wireless local area network connection. The wireless local area network is especially suitable, for example, in mass event contexts. Users can hereby be informed even directly to their communication devices about the possibility of ordering settings. The ordering of settings also in connection with the actual event is easy by applying wireless local area networks. Of course, it is also possible to input settings using the keypad of the device.

In step 402, server IMSS receives service setting orders and the programme 31 processes them in step 403. From the setting orders it is possible to identify the subscriber identifier of the communication device 11.1, 11.1′ ordering the service, for example, in order to arrange invoicing and in order to examine a possible special status. On the other hand, it is also possible to identify the type or model of the device, if not defined in the order message, if, for example, the device by itself or the chat-client 41 being run therein affects, for example, the ordering or use of the service.

Furthermore, programme 31 may be used to bring about user identifiers 14 and corresponding passwords 15. All information can be stored, for example, in database dB located in connection with server IMSS, which database may also be located in memory means MEM1 located in connection with server IMSS. Operator A, B, SP maintains and manages this database dB.

In the following step 404, the generated settings 13-15 can be transmitted to the communication devices 11.1, 11.1′, which have ordered them. Communication devices 11.1, 11.1′ receive the settings 13-15 in step 405.1, 405.2 in a manner known as such, for example, as a data(SMS)message, and store them in their memory MEM4 in order to register with an operator-independent instant message application 31′ and in order to use the service CHAT AB.

FIG. 5 shows some examples of instant message setting data messages 21.1, 21.2 according to the invention, which are received from server IMSS in consequence of an order for the instant message service CHAT AB. Data message 21.1 shows by way of example a general format and data message 21.2 shows a corresponding application example. Service settings 13-15 can be understood as meaning generally all kinds of data required for getting access to the IM service CHAT AB and for carrying out messaging therein.

Thus, according to one embodiment, the instant message settings 13-15 may include, for example, a service access point i.e. address 13, the user's personal service log-in identifier 14 and password 15. In addition, the setting message 21.1 may also include other information 16. An example of such is the IM service's times for the beginning and end of the CHAT AB service or event info in general. Address 13 should be understood as a certain kind of general address, where communication devices 11.1-11.3, 11.1′-11.3′ may thus register independently of operators or at least in such a way that mutual instant messaging can also be carried out by such devices, which are provided with mobile subscriptions of different operators A, B.

A communication device 11.1, 11.1′ which has received service settings 13-15 in a manner known as such is able to process the received data message 21.1, 21.2, for example, in such a way that it is stored automatically for use in the device's 11.1, 11.1′ chat software 41 (for example, in the address/service list). If additional information 16 has been included in the message 21.1, 21.2, it can according to one embodiment even be automatically separated from the actual setting data 13-15 for examination by the user, for example, on the display of the device 11.1, 11.1′. The setting message 21.1, 21.2 with its user identifier 14 and password 15 may be even very complicated, if the user need not, for example, attend separately to its storing.

Service setting 13-15 may also be ordered and delivered in connection with the actual event. It is hereby possible also to apply wireless local area networks, besides a wireless mobile station network 11, 11′, if the functionality of the setting server IMSS is at a suitable distance from the actual place of the event.

FIG. 7 is a flow chart of partial steps when using the actual chat service CHAT AB, and FIG. 6 is a rough schematic view of a server SP running the instant message service. In step 701, the IM application 30′ is activated by the operator's server SP. Application 30′ includes a programme code 31′ stored on memory means MEM3 in connection with the operator's server SP. The programme code 31′ further includes one or more code means 32.1′, which can be executed by the server's SP processor means CPU', which code means are configured to implement the instant message service CHAT AB independently of operators for communication devices 11.1-11.3, 11.1′-11.3′ messaging in the network system 10. Since the specification now concerns an instant message service CHAT AB timed in connection with a momentary mass event, execution of the application 31′ is triggered to be displayed in the network 10 at a moment, which is made known in advance. In order to set and measure the period of time of the maintenance of service CHAT AB, server SP may include timer means (not shown). Server SP is connected to the network system 10 through interface 29′. Interface 29, 29′ may also be a transmission/reception interface for a wireless local area network. For wireless local area network connections servers IMSS and/or SP may include the necessary means for their generation and maintenance.

In step 702.1, 702.2, the users of communication devices 11.1-11.3, 11.1′-11.3′ may from their devices 11.1-11.3, 11.1′-11.3′ activate, for example, a chat client or other such application 41 allowing messaging in the IM service CHAT AB, and in step 703.1, 703.2 they may register with it to the chat application 31′ to be run on that server SP.

In step 704, the chat application 31′ receives registrations of communication devices 11.1-11.3, 11.1′-11.3′. For a possible check of the validity of parties ordering the service, it is possible to arrange a connection between the chat application 31′ and the registration database dB, in case they are separate from one another for some reason. On the other hand, the chat server SP may also have a copy of the registration database dB.

After the registration steps 703.1, 703.2, 704 the devices 11.1-11.3, 11.1′-11.3′ may carry out mutual chat messaging through the agency of chat server SP in a manner known as such, but now, according to the invention, also independently of the operator (steps 705.1-705.3).

Messaging can be carried out through a wireless mobile station network 11, 11′ or also through wireless local area networks, unless this is limited by the distance of the chat application server SP. Invoicing may in the case of a physical wireless mobile station network 11, 11′ be based in a known manner on the quantity of transferred packet data. When wireless local area networks are applied in the messaging, invoicing may be done based on the messaging activity, for example, directly between the service provider SP of the service CHAT AB and the subscriber.

If the chat service CHAT AB being run on server SP is of the temporary type, whereby it is maintained for a limited time only, then the users may be informed in good time of the closing of service CHAT AB, for example, by a text message. The users can thus move over to other forum to continue with their possibly interrupted messaging. Besides or instead of a possible predetermined period of time, the time of maintenance of service AB may also be affected by, for example, the messaging activity emerging on forum AB.

From the instant message service CHAT AB it is possible to arrange a connection also to other chat forums, for example, to Internet based ones. This can be done, for example, as a gateway service IG.

According to the invention, the term “operator”, to which reference has been made on several occasions in the foregoing, can also be understood very broadly. Besides a traditional network operator A, B it can of course also be used to mean, for example, a SP (service provider). Furthermore, the service provider SP may even be the actual organiser of the event. The applications 31, 31′ needed for the invention may also be arranged in several different ways in the data transmission networks system 10, whereby they may be, for example, in the same connection or even in different connections managed and controlled by different parties.

As already mentioned above, it is possible according to one embodiment to maintain in database dB, for example, also a register of such subscription identifiers, which have the right to obtain the the IM service CHAT AB to their communication devices under some special right. Examples of such users can be invited guests or customers of exhibiting tradesmen at fairs or at sports events.

Hereby the corresponding identifier ID can be, for example, on the customer ticket given by the exhibitor or other such to their invited guests, which may entitle, for example, to “priority right” to gain access to the service CHAT AB. An example of this is more advantageous costs of the instant message service, for example, from the point of view of message communication.

The invention can be applied in numerous different situations, but the intention is not in any way to limit the invention to these. Some additional examples, besides those already mentioned above, are various congresses, public places/means of transportation or department stores. Such situations/places/events in general, where many people assemble, who have a need to chat about a theme relating to the situation/place or about some other theme taken up/not taken up beforehand even without eye contact. The invention allows an easy and flexible manner of searching and distributing information and it makes possible a chat connection for a great number of people.

It should be understood that the above specification and the figures relating to it are only intended to illustrate the present invention. Thus, the invention is not limited only to the embodiments presented above or to those defined in the claims, but many such different variations and modifications of the invention will be obvious to the professional in the art, which are possible within the scope of the inventive idea defined in the appended claims.

1. System for implementation of an instant message service (CHAT AB), which system includes data transmission networks, of which at least some are operator-specific, and in connection with the data transmission networks the following are arranged
communication devices, which are entitled to use the data transmission network of an established operator (A, B) and which communication devices are equipped with means (R/T) and with settings for carrying out instant messaging at least with other communication devices entitled to use the data transmission network of the established operator (A, B), and
network elements, which are adapted to implement the instant message service (CHAT A) at least for communication devices entitled to use the data transmission network of the established operator (A),
characterised in that in connection with the network elements means (IMSS) are fitted for transmitting instant message settings to communication devices to implement an operator-independent instant message service (CHAT AB) and which means (IMSS) are adapted under the management of the service provider (SP).

2. System according to claim 1, characterised in that in connection with the means (IMSS) second means (MEM1) are adapted for a user register (dB) of the instant message service (CHAT AB).

3. System according to claim 1, characterised in that the instant message service (CHAT AB) is adapted to be maintained for a time of an established length.

4. System according to claim 1, characterised in that in connection with the means (IMSS) third means are adapted for distribution of settings by using a wireless local area network.

5. Method for implementation of an instant message service (CHAT AB), wherein in the data transmission networks, of which at least some are operator-specific, instant messaging between one another is carried out by several communication devices provided with instant message settings in such a way that a communication device entitled to use the data transmission network of the established operator (A) carries out instant messaging at least with other communication devices entitled to use the data transmission network of the established operator (A, B), characterised in that the instant message settings are transmitted to the communication devices for operator-independent instant messaging.

6. Method according to claim 5, characterised in that the communication devices order the instant message settings with data messages.

7. Method according to claim 5, characterised in that, the instant message service (CHAT AB) is maintained for a limited time.

8. Method according to claim 5, characterised in that the operator (A, B) maintains and manages the user register (dB) of the instant message service (CHAT AB).

9. Method according to claim 5, characterised in that the instant message settings are distributed over a wireless local area network connection.

10. Network element for implementation of an instant message service (CHAT AB), which can be adapted to function in a data transmission network system, whereby the system includes data transmission networks, of which at least some are operator-specific, and in connection with the data transmission networks communication devices are adapted, which are entitled to use the data transmission network of the established operator (A, B) and which communication devices are equipped with means (R/T) and with settings for carrying out instant messaging at least with other communication devices entitled to use the data transmission network of the established operator (A, B), characterised in that in connection with the network element means (IMSS) are fitted for transmitting instant message settings to the communication devices in order to implement an operator-independent instant message service (CHAT AB) and which means (IMSS) are adapted under the management of the service provider (SP).

11. Network element according to claim 10, characterised in that in connection with the network element means are fitted for distribution of instant message settings over a wireless local area network connection.

12. Programme product for distribution of instant message service settings to communication devices, which programme product includes a storage medium (MEM2) and a programme code, which can be executed by processor means (CPU) and which is written in the storage medium (MEM2) for distribution of instant message service settings in a data transmission network system, whereby the system includes data transmission networks, of which at least some are adapted to be operator-specific, and in connection with the data transmission networks communication devices are adapted, which are entitled to use the data transmission network of the established operator (A, B) and which can be provided with settings for carrying out instant messaging at least with other communication devices entitled to use the data transmission network of the established operator, characterised in that the programme code includes a first code means configured to transmit instant message settings to the communication devices for implementation of an operator-independent instant message service (CHAT AB).

13. Programme product according to claim 12, characterised in that the programme code also includes a second code means configured to register the communication device, which has ordered instant message settings.

14. Programme product according to claim 12, characterised in that the programme code also includes a third code means configured to interpret whether the communication device ordering instant message settings fulfils the established special criteria.

15. Programme product for implementation of an instant message service (CHAT AB) for communication devices, which programme product includes a storage medium (MEM3) and a programme code, which can be executed by processor means (CPU') and which is written on the storage medium (MEM3) for implementation of an instant message service (CHAT AB) in a data transmission network system, whereby the system includes data transmission networks, of which at least some are adapted to be operator-specific, and in connection with the data transmission networks communication devices are adapted, which are entitled to use the data transmission network of the established operator (A, B) and which can be provided with settings for carrying out instant messaging at least with other communication devices entitled to use the data transmission network of the established operator, characterised in that the programme code includes a first code means configured to implement an instant message service (CHAT AB) for communication devices independently of operators.

16. Use of a system according to claim 1 in connection with a mass event of limited duration.

17. Use of a method according to claim 5 in connection with a mass event of limited duration.
